(19) United States
(12) Patent Application Publication
(10) Pub. No.: US 2011/0225617 A1
(43) Pub. Date: Sep. 15, 2011

(54) COLLABORATIVE RECORDING NETWORK SYSTEM AND METHOD

(76) Inventor: Selim Shlomo Rakib, Cupertino, CA (US)

(21) Appl. No.: 12/723,630

(22) Filed: Mar. 13, 2010

(51) Int. Cl. H04N 7/173; H04N 7/26

(52) U.S. Cl. 725/109

(57) ABSTRACT

Collaborative video recording method that allows a plurality of networked digital video recorder (DVR) devices to distribute the tasks of receiving and storing digital video content data. To do this, the invention defines a new type of point-to-point (P2P) overlay network, termed a “Fair Use P2P network” designed to facilitate networking among those DVR devices that have legally equivalent access to the same video program content. Here DVR devices will seek out peer DVR devices on the Fair Use P2P overlay network, and advertise their capabilities. A user's DVR, upon determining that its own resources to record the desired program are overly limited, will contact other DVR devices request remote recording and storage services. To view, the user's DVR sends messages to the one or more remote DVR units requesting playback of the stored program data. This data will then be streamed back to the user and replayed.

### BACKGROUND OF THE INVENTION

1. Field of the Invention

The invention is in the general field of digital video recording and redirection technology, and more specifically pertains to Digital Video Recorders (DVR).

2. Description of the Related Art

Digital video recorders (DVR) (sometimes referred to in the alternative as personal video recorders or PVR), such as the various devices produced by TiVo, Dish Network, DirectTV and others, are typically set top boxes equipped with tuners to receive various analog or digital television video programs on various channels, processors (often PowerPC or MIPS based processors often working with additional MPEG-2, MPEG-4 encoder/decoder chips) to compress the video to a more manageable size, and mass storage memory, often mult-gigabyte capacity hard drives, but also solid state memory such as Flash memory. The units are popular because the digital video recorders can be hooked up to a network, such as a telephone network, Internet, or other network and receive program schedule information from one or more centralized servers. The user may then view the upcoming schedule of video programming, select those television programs that look most interesting, and program the Digital video processor to automatically record the programs when they are broadcast. The user can then replay the recorded program at a more convenient time.

Such DVR units are exemplified by various US patents, including Barton et. al., U.S. Pat. No. 6,233,389 and Barton et. al. U.S. Pat. No. 7,529,465, the contents of both of which are included herein by reference, and other patents.

Modern digital video recorders now have multiple tuners that enable the DVR to record on one channel while the user watches a second channel, or even record multiple channels at the same time.

One limitation of digital video recorders, however, is that the DVR hard drive or other data storage memory can easily become filled up with television programs. To minimize the impact of this problem, the units are often automatically programmed to delete the oldest recorded programs to make room for new programs, and this can become irritating because on a heavily scheduled DVR unit, programs only a few days old can be automatically deleted.

Modern DVR units often now include network adapters (i.e. Ethernet adapters, USB connectors), and some DVR additionally allow creation of home networks that enable transfer of pre-recorded programs from a first DVR unit located a residence, to a second DVR located in the same residence, or to a user's computer or other device.

Although some attempts, such as the 4000 series and 5000 series ReplayTV DVR devices have been made to produce DVR units with built in Ethernet connectors and a capability to transmit stored programs to remote units over a network, these units have run into legal difficulties, and are no longer on the market.

In addition to DVR, which can essentially be viewed as a type of video media time shifting device, space shifting devices are also known in the art.

Recently, Sling Media, Inc., Foster City, Calif. introduced the “Slingbox” system and device. This system, discussed in Krikorian, U.S. Pat. No. 7,647,614 and elsewhere is a media broadcasting system, intended for personal use, that allows a user to remotely control a personal broadcaster unit that takes inputs from various media sources, compresses the input, and then retransmits or streams this compressed media data over networks, such as the internet to the user, who will often view the content using a remote computer terminal, video capable cell phone, or other device. This system also allows a remote viewer to remotely control the personal broadcast unit by, for example, changing channels. This type of video redirection is commonly referred to as “placeshifting”.

Unfortunately, despite past work in the field, a number of common situations frequently occur where the present state of the art in video recording and redirection technology is still unsatisfactory. DVR units remain expensive, still have limited recording capability, and are at risk of failing to record television shows in the event of power outages or other service interruptions. Thus further improvements are desirable.

### BRIEF SUMMARY OF THE INVENTION

The invention is designed to lower the costs for DVR units by enabling simpler DVR units with a limited number of tuners, and a limited amount of data storage, to nonetheless perform at a level compatible with more expensive DVR units. The invention also is designed to help overcome the problems of limited DVR video storage capacity, and also help make DVR services more robust to transient service interruptions.

At one level, the invention is a method of collaborative video recording that allows a plurality of networked digital video recorder (DVR) devices to distribute the tasks of receiving and storing digital video content data among different DVR devices. To do this, the invention defines a new type of point-to-point (P2P) overlay network, termed a “Fair Use P2P network” designed to facilitate networking among those DVR devices that have legally equivalent access to the same video program content. This network is an “overlay” network because it is designed to ride on top of existing networks, such as CATV networks, DSL networks, the Internet, and other networks.

In use, DVR devices will seek out peer DVR devices on the Fair Use P2P overlay network, and advertise their capabilities, such as amount of free recording memory available, and anticipated tuner availability schedule. The system will often be used on a semi-automatic basis. Here a user (the initial requestor), who may have pre-authorized use of external DVR units to supplement the storage space or tuner availability on his or her own DVR, may attempt to set a schedule for a future recording that may exceed available DVR memory storage space, or tuner capability (i.e. recording multiple programs at the same time). As another possibility, a user in a region prone to unreliable electrical power, or who is planning to be away from the home for an extended period of time, may wish to ensure with extra reliability that a particular program will be recorded.

The user's DVR, upon determining that its own resources to record the desired program are overly limited, or upon receiving a command to schedule a redundant backup recording, will contact other DVR devices on its Fair Use P2P overlay network and request remote recording and storage services. Often this request can be mediated by a token exchange process in which the various DVR devices barter amongst themselves in a token based “economy” in which tokens are required to engage remote recording and storage services, and such tokens can either be purchased or earned by providing remote recording and storage services for other DVR devices on the network.

After the negation and optional token exchange process, one or more remote DVR units will record the desired program, compress it, and store it on their own remote (local to the remote DVR) storage devices. To avoid copyright issues, this remote storage may be optionally encrypted or otherwise sequestered so that a program that a remote DVR that did not itself request to record the same program may not access the program.

When the user (initial requestor) wishes to view the program, the user's DVR, upon user request, will then send messages to the one or more remote DVR units requesting playback of the stored program data. This data will then be streamed back to the user over the Fair Use P2P network, be acquired by the user's DVR, and then replayed for the user.

Other variations and elaborations on this basic, such as premium “super-nodes” that can provide extra storage services, sell tokens, and also provide premium content will also be discussed.

### BRIEF DESCRIPTION OF THE DRAWINGS

FIG. 1 shows a connection diagram for a prior art (computer-based) P2P network functioning without a central server.

FIG. 2 shows an example of various DVR devices, some receiving broadcast video content data from source “A”, and others receiving broadcast video content from source “B”, and using the identity of the broadcast video content source as a criterion for determining if a connection to another DVR device is permissible.

FIG. 3 shows an example of the two distinct “Fair Use” P2P networks that would eventually be established from the example in FIG. 2. Note that all the DVR devices in fair use network 1 have the same rights to view the content from source A, and all of the DVR devices in fair use network 2 have the same rights to view the content from source B.

FIG. 4 shows an example of the P2P network message exchanges required to request a remote DVR to record a video program and subsequently retransmit this video program to the requestor DVR at a later time.

FIG. 5 shows an example of the P2P network message exchanges required to request multiple remote DVRs to record a video program and send back portions of the video program in an interlaced manner for faster downloading.

FIG. 6 shows an example of a “token exchange” system among DVR nodes in the P2P network designed to encourage users to offer unused DVR resources to others in exchange for credit to allow them to use other's unused DVR resources.

FIG. 7 shows a “super-node” that can provide additional storage and playback resources for the Fair Use P2P network, and that can additionally provide tokens in exchange for micropayments.

FIG. 8 shows a “premium content super-node”, here run by an authorized content provider that has made arrangements to obtain additional video program material from an authorized source, and in turn can offer additional video program material to the Fair Use P2P network either gratis, or in exchange for tokens or micropayments.

FIG. 9 shows an example of a DVR interface for a DVR connected to a fair use P2P network that also has premium content super-nodes attached. The basic broadcast channels are shown on the top, and the premium content offered by the premium super-nodes are shown on the bottom.

FIG. 10 shows an example where multiple DVR devices connected to a fair use P2P network request remote recording or playback services for the same program, and from the same remote DVR device or devices.

### DETAILED DESCRIPTION OF THE INVENTION

Nomenclature: In this specification, the generic term “Digital Video Recorder” or “DVR” will be used in the broad sense. Although “traditional” set top box type DVR units with hard drives, tuners, processors MPEG-2 or MPEG-4 or other video compression and decompression units, and network interfaces are, of course encompassed by this terminology, alternate types of DVR units are also possible. In particular, the invention enables use of alternate format DVR units, including miniaturized devices that may only have a single tuner and flash memory, and which may plug in as a module to a computer, television, or even directly onto an antenna or cable outlet, are also indicated by this DVR nomenclature. Other DVR configurations include computers, unitized DVR television monitor systems, and the like.

In one embodiment of the invention, the DVR devices are configured to be able to connect to one another either directly, or by intermediate use of routers, and form a peer-to-peer (P2P) network, and make their video receivers and storage devices mutually available to one another according to a predetermined protocol. Thus each DVR device (or node) on the P2P network can act as both a client and a server to other DVR devices on the network.

Unlike prior art P2P networks, however, which can often act to allow new nodes to join with other nodes on the P2P network either without restriction, or with limited restriction such as registration with a centralized registration server, in a preferred embodiment, the invention's P2P network will impose rather stringent limitations as to what new nodes are allowed to join a given P2P network.

These stringent restrictions are heavily influenced by copyright law. In the US and many other countries, unauthorized reproduction of program content is generally considered to be a copyright violation unless this reproduction falls within certain “fair use” limitations. One of the most important fair use limitations is the consideration, under Title 17 §107, of the “effect of the use upon the potential market for or value of the copyrighted work.” To the extent that copies do not impact the potential market or value of the copyrighted work, then such copies fall under fair use.

Thus, for example, under Sony Corp. of America v. Universal City Studios, Inc. 464 US 417 (1984), the US Supreme Court determined that making individual copies of complete television shows, thus allowing time shifting, was fair use, and that devices that enabled such time-shifting were not liable for infringement.

In particular, the court determined: “When one considers the nature of a televised copyrighted audiovisual work . . . and that time-shifting merely enables a viewer to see such a work which he had been invited to witness in its entirety free of charge, the fact . . . that the entire work is reproduced . . . does not have its ordinary effect of militating against a finding of fair use.”

The Sony ruling has stood the test of time, and organizations that ignore this ruling do so at substantial risk. Indeed, other attempts (such as the ReplayTV 4000 series devices) to produce digital video recorders equipped with Ethernet network adapters, that could freely share programs with other users that had not been offered the program free of charge, were found to violate US copyright law.

Here, in order to preserve compatibility with the Sony decision, a new type of “Fair Use P2P network” method and system is described. This “Fair Use P2P network” is generally designed with the goal of only allowing nodes (DVR devices) that have equivalent free or equivalent pre-paid access to any given digital video content source, program, or data to join and potentially allow shared use of video receivers and storage devices.

It should be understood that as a practical matter, this fair use P2P network will exist primarily in the form of software that in turn is running on DVR devices with network interfaces. That is, the majority of the discussion of this specification is essentially a functional definition of this fair use P2P network software, and how it will react in various situations.

This fair use P2P network software may be stored in the main DVR program memory used to store other DVR functionality, such as the DVR user interface, and the like, and will normally be executed on the main processor, such as a power PC processor, MIPS processor or the like that controls the main DVR functionality. The fair use P2P network software will be able to control the functionality of the DVR network interface, tuner, compression devices (i.e. MPEG-2, MPEG-4, or other compression chips or algorithms) and storage devices. Once the user authorizes or enables use of the fair use P2P software, many of the P2P software algorithms and processes described in this specification will then execute on an automatic or semi-automatic basis.

The Fair Use P2P network can be implemented using a variety of physical layers and a variety of application layers. Often it will be implemented as an overlay network that may overlay the same network that distributes the original digital video programs among the plurality of different nodes or different DVR devices.

One important distinguishing characteristic of the fair use P2P network protocol, however is that it does not automatically assume that another DVR device connected to the same network is an acceptable DVR device to interface with. Rather, the initial “handshaking” protocols when any two given P2P connected DVR devices communicate is designed to verify that the two DVR's have equivalent access to the same type of video media from the same type of mass video media distribution source. Here these mass video media distribution sources will often be called “broadcast” sources. Although intended as a analogy to television broadcast stations that blanket any given area with identical copies of the same media, in this context, “broadcast” will also refer to video media being distributed by mass video media distribution sources of any type, including cable, internet, DSL, satellite, and of course actual broadcast sources.

The protocols used to verify that any two given DVR devices have access to the same “broadcast” video media sources will vary on a case by case basis. In some cases the DVR may obtain this information from their cable operator or broadcast station, and be able to compare cable operator or broadcast station identification numbers directly. For example, here the DVR may scan or parse the Electronic Program Guide (EPG) or Interactive Program Guide (IPG) for a cable or satellite operator, and use this information. Alternatively the DVR may scan or parse the Station Identification information for a broadcast station, and use this information. In other cases this identification may be more difficult, and here use of a central registry “Fair Use super-node” that keeps track of many various media sources, and assumes responsibility for assigning each DVR to the proper media access group, may be utilized.

Useful information relative to the fair use status of the cable operator, satellite operator, broadcast station, internet content provider, etc. (collectively referred to as “broadcast operator”) include geographical status of video content distribution, type of video content, and video content service levels. Useful information relative to the fair use status of an individual DVR device include DVR location (by street, zip code, internet address, or other means), DVR broadcast service provider, DVR service level (i.e. standard content, premium content), and optionally DVR billing status. In the case of multiple broadcast service providers (i.e. access to many digital TV stations, access to more than one cable or satellite provider, etc.), then the full list will be a comprehensive list of all providers. In this situation, it is quite possible that a DVR may have access to one Fair Use P2P network for part of its broadcast content, and access to a different Fair Use P2P network for a different part of its broadcast content.

Upon initialization, and periodically thereafter, a DVR device may communicate with the central registry, exchange information such as DVR zip code, local telephone number or Internet address, optional user identification, cable or satellite provider, service level and the like, and be assigned a fair use identification code unique to the set of media that the DVR will have access to.

In this scheme, the fair use super-node will often maintain a list of broadcast digital media sources and the broadcast characteristics of these broadcast digital media sources. The fair use super node can also maintain a list of different fair use DVR devices and the DVR characteristics of these different Fair Use DVR devices.

Thus when a DVR device contacts the Fair Use super-node on the P2P network, the Fair Use super-node can determine the DVR characteristics of the device, and assigns this DVR device a media access code that corresponds to the broadcast characteristics of the broadcast digital media source that supplies the digital video content data to the DVR device. This DVR device can then use this media access code as criteria to determine if another DVR device has equal access ability and equal access privileges to receive digital video content data.

Here some examples of the various types of networks and schemes that may be used to implement the invention may be useful.

### EXAMPLE 1

Here reference is made to copending application Ser. No. 12/692,582 “Distributed Cable Modem Termination System”, the contents of which are incorporated herein by reference.

In example 1 all the DVR devices may be connected to the same neighborhood CATV cable and all receive the same digital video content from the same cable head. In this very limited case, then the overlay network may, for example, be an overlay network that operates over an area that is restricted to empty RF channels on the neighborhood RF CATV cable. Here, this P2P network would be quite limited in potential size, since typically at most 50 to 200 households connect to each neighborhood CATV cable.

### EXAMPLE 2

In this more useful example, the DVR devices are connected to a CATV cable that in turn connects them to the Internet via supplemental services, such as DOCSIS data services. Here, although the digital video content may be delivered to the various DVR devices using non-internet protocols (i.e. QAM modulated digital TV channels), the DVR devices in turn will connect to other DVR devices using internet protocols, such as TCP/IP, and form Fair Use P2P networks over substantially broader area.

### EXAMPLE 3

As another alternative, in the case where the DVR devices are receiving broadcast digital television signals from a particular transmitter, and in turn are attached to another network such as the Internet through cable DOCSIS data services, DSL links, and the like, then the Fair Use P2P network would consist of those DVR devices within receiving range of the particular broadcast station.

### EXAMPLE 4

As yet another alternative, in the case where the DVR devices are receiving satellite digital television signals, and all have authorized access to the same range of channels, and all in turn are again connected to another network such as the Internet through cable DOCSIS services, DSL links and the like, then the Fair Use P2P network would consist of those DVR devices within the footprint of the satellite beam, and which are using that particular satellite service, which might potentially be an area the size of a continent.

These examples of various Fair Use P2P networks are based upon the assumption that the video content will normally consist of program content plus commercials, and further assume that although the main program video content may be relatively standardized between different sources (i.e. a broadcast station on the East Coast may broadcast the same main program as a different broadcast station on the West Coast), other content, such as commercials, are more likely to differ between sources. Thus, in the simplest example of a Fair Use P2P network, the commercials themselves are assumed to be also covered by copyright, and a more conservatively implemented Fair Use P2P network will thus strive ensure that all members of the network must view the same commercials as well. As will be discussed later, more sophisticated or aggressively implemented Fair Use P2P networks using super-nodes for premium content are also possible.

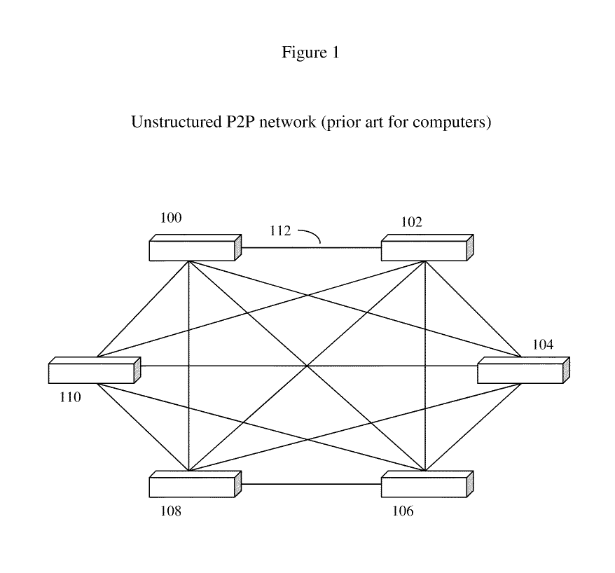

FIG. 1 shows an example of a prior art P2P network. Here all nodes in the network (100, 102, 104, 106, 108, and 110) are usually computers, and the P2P network is usually an overlay network functioning on top of another network such as the Internet. There the various ways in which messages may be exchanged between different nodes in the P2P network are shown as lines (112). Thus FIG. 1 shows that any node may connect and exchange messages with any other node, either directly, or through use of intermediate routers and other network interface devices, as is common for networks such as the Internet.

This diagram thus is a good example of various prior art unstructured P2P networks that allow nearly any type of node to join. Examples of such decentralized P2P networks include Gnutella and Freenet. Some commonly used computer programs that make use of such decentralized P2P networks include Limewire, utorrent and others.

Unfortunately, due to the unrestricted nature of the P2P connections, intended or unintended exchange of copyright material is relatively common, making the legal status of such networks, at least from the copyright perspective, unclear.

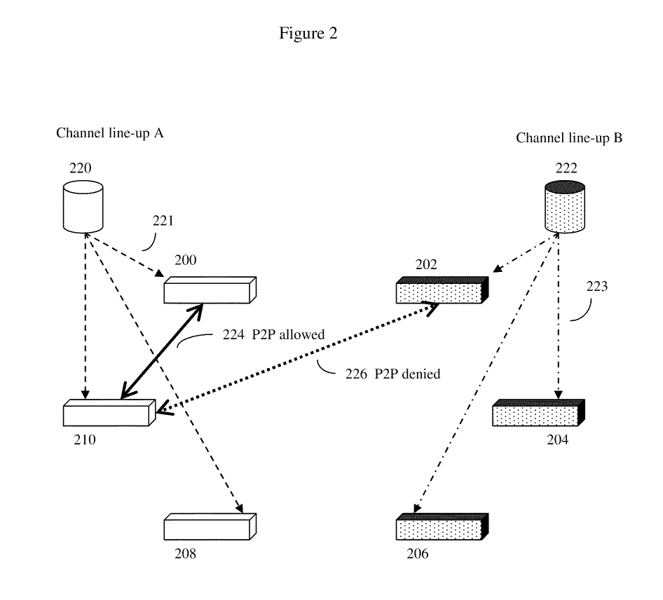

FIG. 2 shows an example of an alternative model. Here the various DVR devices are arranged in different geographic or user service areas. All, however, have network interfaces and in this example, all are connected to the same network, such as the Internet. In this model, some DVR devices (200), (210) and (208) receive broadcast content from video source A (220), while other DVR devices (202), (204), (206) receive broadcast content from video source B (222). Here dashed lines (221) show the identical video content being broadcast from video source A (220), while dashed lines (223) show the identical video content being broadcast from video source B (222).

In this situation, it is assumed that each DVR device (200, 202, 204, 206, 208, and 210) is connected to a network through an appropriate network interface, and that all of the DVR devices are implementing the fair use P2P software protocols described in this specification.

Since no P2P network has yet been formed, the fair use P2P software in each DVR device will attempt to establish P2P connections with other peer DVR devices. Here the criteria for establishing the connection, as previously discussed, is that the remote DVR device must be receiving broadcast content from the same broadcast video source A (220) or B (222).

In this scenario, when DVR device (210), which receives its broadcast content from video source A (220), attempts to establish a P2P link with remote DVR device (202) that receives broadcast content from a different video source B (222). Here the fair use media access codes will not match up correctly, and the P2P connection will be denied (226). However when DVR device (210) attempts to establish a P2P link with a remote DVR device (200) that receives its broadcast content from video source A (220), then the fair use media access codes will correctly match, the connection will be accepted (224), and a P2P link will be formed. That is, each DVR can store a record of the other DVR's address or access code, and know that it is part of its particular fair use P2P network.

More specifically, when a DVR equipped with fair use P2P software first establishes a contact with the network, the fair use P2P software on the DVR will instruct the DVR to bootstrap and find another fair use P2P DVR with privileges to access the same broadcast content from video source A (220) (broadcast access privileges). This bootstrap process can work by many methods. Often a list of potential nodes or super-nodes will be included as part of the fair use P2P software, and these nodes or super-nodes will contain a list of other known fair use DVRs with the same broadcast access privileges. Upon connecting with these nodes or super-nodes, the fair use P2P DVR can download a list of the addresses of other fair use P2P DVRs with the same broadcast access privileges. The fair use P2P DVR can then connect with other fair use P2P DVRs, verify that they have the same broadcast access privileges, and store a record of these other fair use P2P DVRs with the same broadcast privileges. If the fair use P2P DVR contacts another fair use P2P DVR with different broadcast privileges, the address of this improper other fair use P2P DVR can either be discarded, or alternatively stored in a “forbidden” list.

One advantage of the fair use P2P network over other P2P networks is that the burden of search is far less than a normal P2P network. This is because there is almost no need to do extensive searches for content. Content will either be created on specific remote DVR at the request of the local DVR, or alternatively content will reside on a relatively few premium super-nodes (to be discussed). Given this reduced search burden, a wide variety of search methods, some quite simplistic, can thus be used, and there is a lesser need to hop from node to node (DVR to DVR) searching for content. Rather, what node to node hopping that will be done will primarily directed towards finding DVR with free receiver and storage capacity available for use by remote clients.

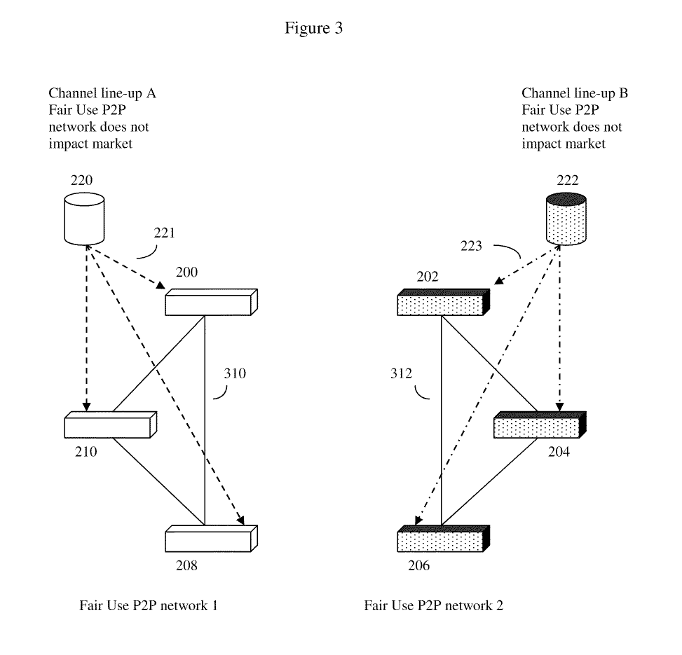

FIG. 3 shows an example of the two different P2P networks that would eventually form using the FIG. 2 example. Fair use P2P network 1 would consist of DVR units (200), (210), and (208) that all have equivalent access to broadcast source “A”. These are all connected to each other, and lines (310) show the various ways in which units or nodes (200), (208), and (210) may communicate over their respective P2P network. As can be seen, communication between different nodes in this first P2P network is again quite free and unrestricted, and any node can connect with any other node.

Similarly P2P network 2 consists of DVR units (202), (204), and (206) that all have equivalent access to broadcast source “B”. These are all connected to each other, and lines (312) show the various ways in which units or nodes (202), (204), and (206) may connect to each other.

Note that from a “fair use” perspective, DVR units (200), (210), and (208) are all equally authorized and capable of receiving broadcast video programs form broadcast source “A”, and thus, within certain limits, an exchange of data among the DVR units will not materially affect the “potential market for or value of the copyrighted work”. This is why the P2P networks formed based on fair use considerations are designated as “fair use P2P networks. Here there are two fair use networks, one receiving video from broadcast source “A” and the other one (composed of DVR units (202), (204), (206) receiving video from broadcast source “B”.

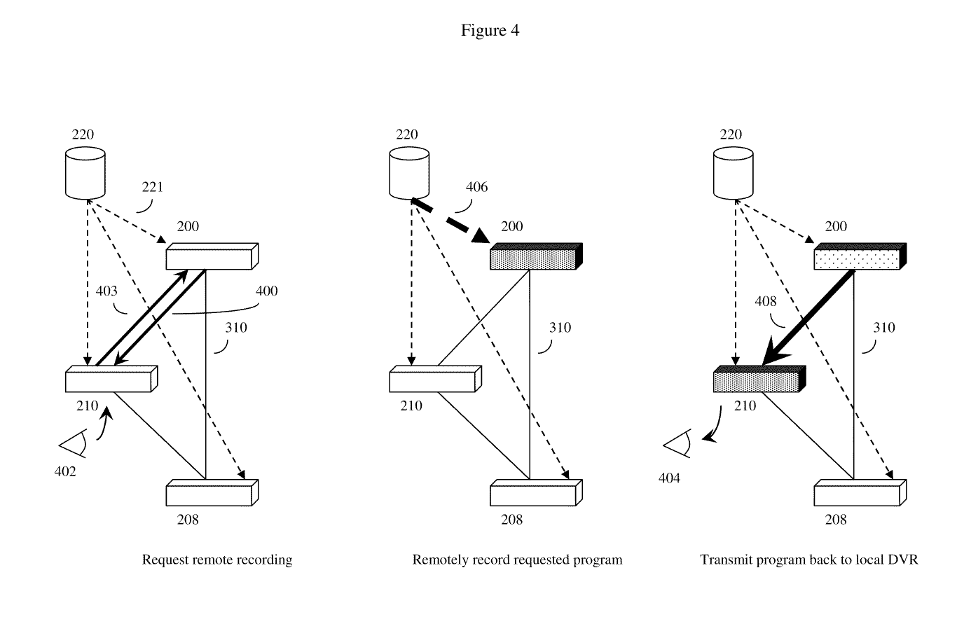

FIG. 4 shows an example of some of the various P2P handshaking and message exchange protocols that the invention's software may implement in order to establish a remote recording session. In this example, remote DVR device (200) advertises that it has excess available storage space and receiver capability at various future times by message exchange to DVR (210) by P2P message (400). This communicates a willingness to serve as a remote receiver and storage unit to other DVR units within the same fair use P2P network.

User (402) interested in recording a video program at a future time requests local DVR (210) to record this program. Local DVR (210), however, may be low on storage space or may have a conflict with another program that limits receiver capability. Alternatively, user (402) may be worried about unreliable power or other issues, and may simply want to request a backup remote recording to ensure that the program is really recorded.

In either event, local DVR (210), knowing that DVR (200) is willing to offer remote receiver and storage services, sends a recording request message (403) to remote DVR (200). Remote DVR (200) agrees to take the request (not shown). The request asks that remote DVR (200) record a particular video program on a particular channel at a particular future time. These times can normally be found by looking at the broadcast schedule for broadcast source “A” (220), and in many cases, standard DVR functionality already includes an ability to quickly find this broadcast schedule.

At the appropriate time that the requested program is scheduled for broadcast by (220), remote DVR (200) records the program (406) from broadcast source A (220). In the process of recording, remote DVR (200) will usually compress the broadcast video program to a smaller size for efficient storage using standard or custom compression programs such as MPEG-2, MPEG-4, and the like. To further comply with fair use laws, remote DVR (200) may optionally either encrypt the program according to a key provided by local DVR (210) (or alternatively a key server super-node), or otherwise shield the user of DVR (200) from the recorded program, unless the local user of DVR (200) has also independently requested that the program be recorded.

At a later time when user (404) (which may be the same user, or another user authorized to view the content) wishes to view the content, user (404) may request local DVR (210) to in-turn request playback from remote DVR (200) (message from local DVR (210) to remote DVR (200) not shown). Remote DVR (200) will play back the now compressed broadcast program (408) across the P2P network to local DVR (210), where it may then be viewed by viewer (404).

Alternatively, when local DVR (210) signals to remote DVR (200) that it now has adequate storage space to receive and store program (406), the download process (408) may be done automatically before user (404) requests it and the program (406) will now reside on local DVR (210) and be instantly ready for viewing when user (404) requests it.

Various schemes can be used to download the requested program (408) from the remote DVR (200). If remote DVR (200) is not protected by a firewall, local DVR (210) may simply contact and request file transfer. If remote DVR (200) is protected by a firewall, then local DVR (210) can send a push request or push proxy request to DVR (200), using, for example, the HTTP protocol which usually passes through firewalls.

Like other P2P protocols, the fair use P2P protocols may make use of packet queries (here often called messages) analogous to “ping” to discover other fair use P2P DVR units. The fair use P2P protocol may make use of a “pong” like packet query in which a remote DVR responds to an earlier ping. The fair use P2P protocol may also have a “query” like packet query to discover available resources on remote DVR units (or alternatively to advertise resources and inquire if use of the resources is needed). Other fair use P2P protocol messages or packet queries include “query hit” in which a DVR responds to a query, and “push” to download the stored data.

As previously discussed, some messages or packet types that are unique to the fair use P2P network include a new “record” or “recording request” message or data packet (403), from the local DVR (210) to the remote DVR (200), as well as a new “record acknowledge” message or data packet (not shown) from the remote DVR (200) to the local DVR (210).

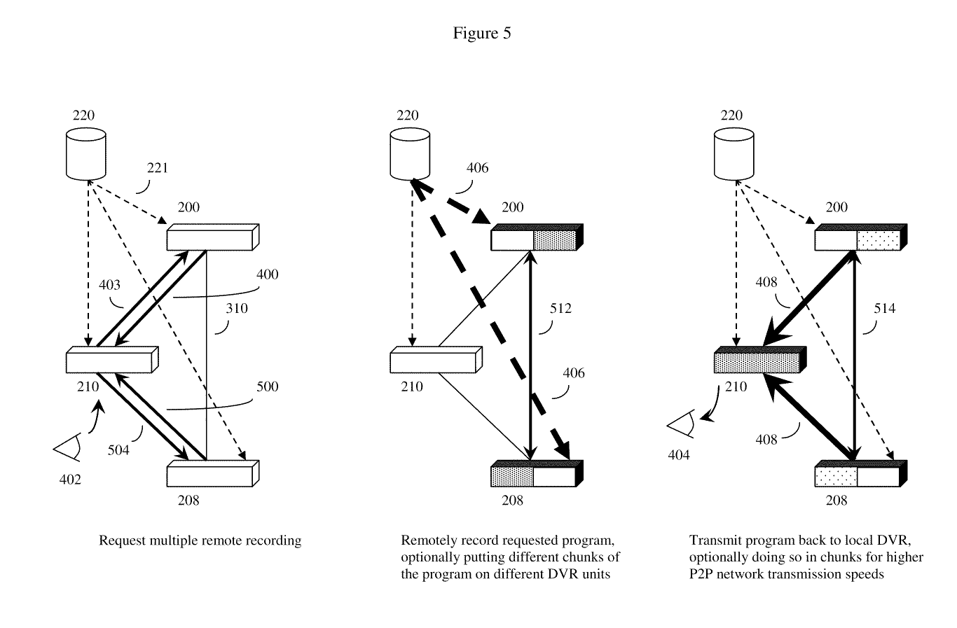

FIG. 5 shows an example of an alternate recording scheme in which the requested video program is recorded on more than one remote DVR, either for redundancy purposes, or alternatively to obtain faster playback by breaking the program into multiple chunks during the playback process, and then reassembling the complete program again at the local DVR unit.

In this example, remote DVR devices (200) and (208) advertise that they have available storage space and receiver capability at various future times by message exchange to DVR (210) by P2P message (400) and (500). User (402) is again interested in recording a video program at a future time, and requests local DVR (210) to record this program. Local DVR (210) as before may be low on storage space or may have a conflict with another program that limits receiver capability. Alternatively, user (402) may again be worried about unreliable power or other issues, and may simply want to request remote recording to ensure that the program is recorded.

Here, however, local DVR (210) may know, from past analysis of P2P traffic rates, that playback speeds from remote DVR units (200), (208) may be inadequate unless the multiple remote DVR units cooperate to send different portions of the video program back in different chunks. Alternatively, local DVR (210) may know from past experience that remote DVR units (200) and (208) have sub-optimal reliability, and thus may wish redundant recordings in order to improve reliability.

In either event, local DVR (210) sends a recording request message (403), (504) to remote DVR (200), and to remote DVR (208) and remote DVR (200) and remote DVR (208) agree to take the request (not shown).

Again at the appropriate time that the requested program is scheduled for broadcast by video source A (220), remote DVRs (200) and (208) record the program (406) from broadcast source A (220). In the process of recording, remote DVR (200) and (208) may optionally send P2P messages to each other (512) (as well as exchange messages with DVR (210), not shown) and agree on a mutually acceptable scheme to divide the recording and storage duties, such as which DVR will record what portions of video program (406). The DVR units (200) and (208) will again usually compress the broadcast video program to a smaller size for efficient storage using standard or custom compression programs such as MPEG-2, MPEG-4, and the like. To further comply with fair use laws, remote DVR (200) and (208) may optionally either encrypt the program according to a key provided by local DVR (210), or otherwise shield the users of DVR (200) and (208) from the recorded program unless one or more of the users has independently also requested that the program be recorded.

Messages or data packets (512) represent another type of message or packet types that are unique to the fair use P2P network. Message (512) can be viewed as being recording synchronization message commands sent between the various DVR (210), (200), and (208) involved in the multiple remote site recording process. An analogous message to this is a recording synchronization message reply that a DVR involved in the remote recording process can send back to the other DVR in response to acknowledge the first recording synchronization message command.

Similarly messages or data packets (514) represent another type of message or packet types that are unique to the fair use P2P network. Message (514) can be viewed as being playback synchronization message commands sent between the various DVR (210), (200), and (208) involved in the multiple remote site playback process. An analogous message to this is a playback synchronization message reply that a DVR involved in the remote playback process can send back to the other DVR in response to acknowledge the first playback synchronization message command.

Other protocols useful to this process include the use of standard checksums (CRC, SHA-1, and the like), metadata, and the like. Further discussion of various exemplary P2P protocols and methods may be found in Taylor and Harrison, “From P2P to Web Services and Grids: Peers in a Client/Server World”, Springer (2004) and Oram “Peer-to-Peer: “Harnessing the Power of Disruptive Technologies”, O'Reilly (2001).

At a later time when user (404) (which may be the same user, or another user authorized to view the content) wishes to view the content, user (404) may request local DVR (210) to in-turn request playback from remote DVR (200) and (208) (message from local DVR (210) to remote DVR (200) and DVR (208) not shown). Remote DVR (200) and (208) will play back the now compressed broadcast program (408) across the P2P network to local DVR (210), where it may then be viewed by viewer (404). In doing this, remote DVR units (200) and (208) may again optionally coordinate their download efforts by exchanging P2P messages (514) between each other (as well as optionally with local DVR (210) not shown) to ensure, for example, that if the program is being played back in chunks, the handoff between the different DVR units (200) and (208) handing the different chunks is performed in a coordinated and effective manner.

Alternatively, as before, when local DVR (210) signals to remote DVR (200) and remote DVR (208) that it now has adequate storage space to receive and store program (406), the download process (408) may be done automatically before user (404) requests it, and the program (406) will now reside on local DVR (210) and be instantly ready for viewing when user (404) requests it.

User Interfaces:

It should be appreciated that the Fair Use P2P network protocols and methods will additionally encompass various user interfaces that a local DVR will present to the local user. Such interfaces are typically presented as on-screen menus with options that a user can select, often by way of a remote control device that sends commands to the local DVR.

The user interfaces for a Fair Use P2P network will typically consist of menus and screen options that allow a user to select to cause the user's local DVR to join a Fair Use P2P network or not, to determine if to allow the local DVR to supply receiver and storage services to the Fair Use P2P network, and if so how much (i.e. how many receiver/tuner units and how much memory space), status of the user's Fair Use P2P token or credit account, supplemental user information such as zip code, credit cards, online payment accounts, etc., and restrictions as to which members of the user's household may purchase or view premium content.

Other interfaces can give information as to the status of the Fair Use P2P network—i.e. how many remote DVR devices are available to provide services, and the reliability and/or download speed for the remote DVR devices, presence of various super-nodes, and the like.

The Fair Use P2P interface may also include menus to schedule future remote recordings either automatically when the user's local DVR determines that its own resources are too low, or manually when the user requests it. Other options include selection of automatic download of remotely recorded programs when the user's local DVR determines that it now has sufficient resources to retrieve the remotely recorded programs. Alternatively the user may select manual download of the remotely recorded programs. Other options include menus controlling how many remote DVR units will be asked to record a program (for either redundancy or data download speed purposes), and user interfaces to view video program data or use options available on remote super-nodes.

Tokens: the Fair Use P2P Network Economy:

Unfortunately, unless there is some way to encourage users to share their DVR resources, the fair use P2P system may encounter a difficult situation in which many local DVR users attempt to request services from remote DVR devices, but there are very few remote DVR devices that have been set up to offer services.

To encourage a reasonable balance between local DVR requesting remote recording services, and remote DVR offering recording systems, in an optional embodiment, it may be useful to additionally implement a micropayment or token exchange system as part of the Fair Use P2P network protocols. Again, these protocols will essentially reside in (be a part of the) DVR software designed to implement the fair use P2P network.

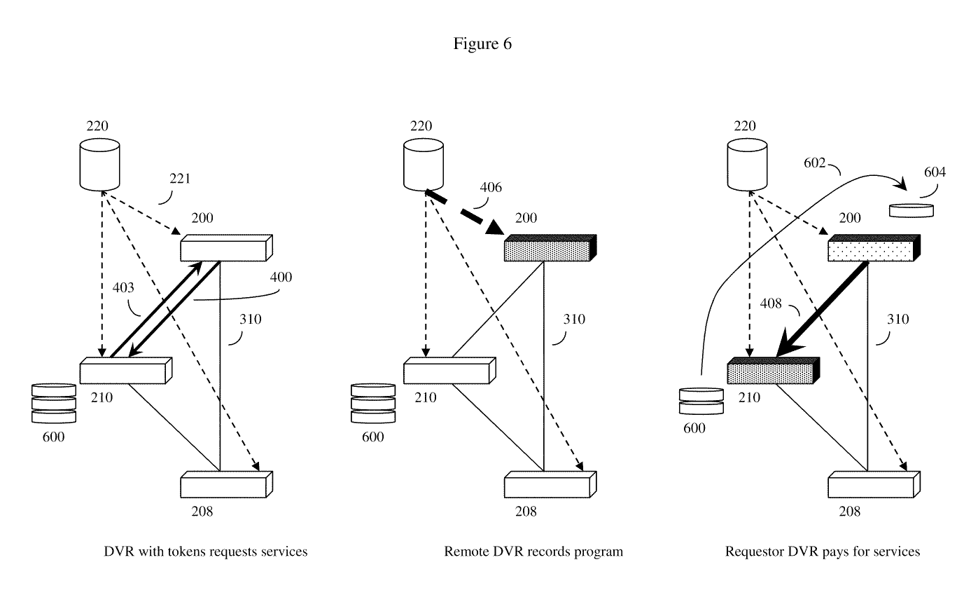

FIG. 6 shows an example of a “token exchange” system among DVR nodes in the P2P network, designed to encourage users to offer unused DVR resources to others in exchange for credit to allow them to use other's unused DVR resources. Here the overall scheme is very similar to that previously discussed in FIG. 4, with the difference being that now the Fair Use P2P protocol also incorporates the concept of “tokens” (i.e. “credits, micro-payment, etc.). Each DVR unit or node (200), (210), (208) will usually have a variable number of tokens assigned to it, with the number varying from 0 to any arbitrary larger number, or possibly even being a negative number if “credit” is to be implemented. In this illustration, assume that DVR unit (210) presently possesses three “tokens” (600).

DVR unit (210) will “pay” for using the remote recording services of remote DVR unit (200) by transferring tokens out of DVR (210)'s internal token store or counter (600) to the token store or counter of remote DVR unit (200). In this example, the Token transfer (602) is shown as being completed once remote DVR unit (200) successfully transfers the remotely recorded program (408) back to local DVR (210). Other schemes are possible, of course. Remote DVR unit (200) may wish to inquire if local DVR unit (210) has enough available tokens before starting to remotely record the program (406). Alternatively remote DVR unit (200) may wish to charge some tokens to remotely store the video program (406), and then charge additional tokens to then play back remotely stored video program (406).

Although the DVR devices of this invention, using Fair Use P2P network methods, can significantly add value by enabling both simpler and lower cost DVR devices with smaller amounts of storage memory and fewer receivers, as well as improving overall recording reliability, the capabilities of the basic Fair Use P2P network DVR recording system can be improved still further by the addition of super-nodes to the system.

Super-Nodes:

In some cases, super-nodes with enhanced storage and playback capacity may join the Fair Use P2P network. Although these super-nodes need not be affiliated with content providers, super-nodes that are affiliated with content providers will have certain advantages, as will be discussed.

One of the simplest super-node functions can be to serve as a source of additional recording and storage resources, and also optionally can serve to partially monetize the fair use P2P token exchange system.

As previously discussed, some measure of token exchange between DVR units on the Fair Use P2P network may be useful because it will help prevent abusive or freeloading situations where remote DVR units receive no value in exchange for providing receiver and recording services for other DVR units.

A super-node operator can serve as a source of tokens for this Fair Use P2P network token economy. Here, tokens can be provided for a price—for example for a micropayment, or alternatively for performing a service for the super-node operator, such as viewing extra commercials. It is likely, for example, that many DVR owners would consider viewing an extra 15 or 30 second commercial to be a small price to pay for the convenience of having a greatly extended recording capacity.

Additionally, a super-node operator can also extend the amount of video programming material that is potentially available on the Fair Use P2P network. For example, a super-node operator could advertise additional video material for viewing on either a micropayment basis, a token basis, or on in exchange for viewing extra commercials basis. For example, supplemental material that might otherwise only be available on the internet can be provided, or alternatively even programs that were never originally broadcast by the super-node operator can be made available on some form of fee basis. Thus the super-node operator can extend the Fair Use P2P network to now encompass Fair Use and authorized premium material.

Thus super-nodes can differ from normal DVR nodes in various ways. The super-nodes can offer a much higher level of available receivers and storage capacity. The super-nodes can also serve as a source of token creation and consumption. The super-nodes may, for example, serve as a bridge between the token exchange methods used by the basic Fair Use P2P network (FIG. 6) and a micropayment based method linked to the real economy. Here, for example, a super-node may offer tokens in exchange for electronic payment (in dollars, cents, fractions of a cent, or other currency). Since the super-nodes would also offer a large amount of available receivers and storage capacity, the super-nodes would then also serve as a way to “soak up” or capture circulating tokens and remove them from the Fair Use P2P network economy.

Additionally, super-nodes can help “seed” the Fair Use P2P network by, for example, creating lists of other DVR units (e.g. 200, 210, and 208) that have equivalent access and rights to a broadcast video source A (220), thus helping new DVR units rapidly obtain full access to the Fair Use P2P network.

As previously discussed, some super-nodes may not be affiliated with content providers, such as broadcast video source A (220), and other super-nodes may indeed be affiliated with content providers, in which case such super-nodes could add even more services and value to the Fair Use P2P network.

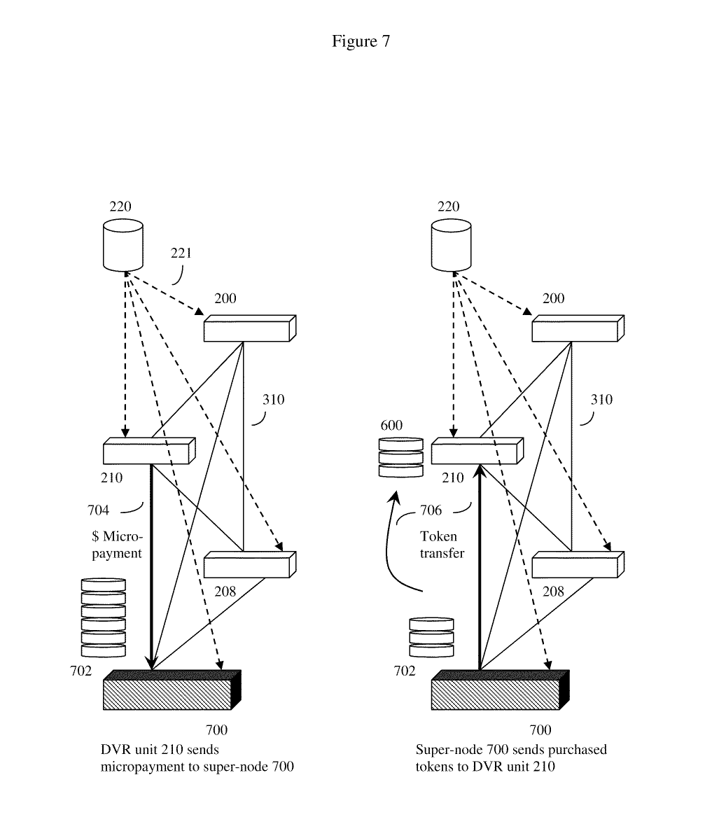

One of the simpler super-node implementations is shown in FIG. 7. Here “super-node” (700), which need not be operated by an authorized content provider, can provide additional storage and playback resources for the Fair Use P2P network, and can additionally provide tokens in exchange for micropayments.

In this scheme, assume that super-node (700) has previously performed many recording services for other units, and has accumulated a large amount of tokens (702). (To prevent token “inflation”, here we assume that super-node is (700) is earning its tokens honestly, rather than simply “printing” tokens). At the same time, super-node (700) will likely have no need for the recording services of other nodes (200), (208), (210), and thus may agree to only part with its own tokens in exchange for cash payments or micropayments.

Alternatively, super-node (700) may give tokens away in exchange for users viewing commercials. Here, because super-node (700) may know something about the viewing preferences of the various DVR units on its fair use P2P network from past requests to record programs, such commercial providing services may be highly sought after by advertisers.

In this scheme, local DVR unit (210) is out of tokens, and wishes to obtain more tokens to engage additional remote recording services. To purchase tokens, DVR unit (210) sends a message (704) on the Fair Use P2P network to super-node (700) requesting tokens in exchange for an authorized payment or micropayment of a small amount of cash. When the transaction is received and is processed, super-node (700) sends a message back to local DVR (210) by Fair Use P2P network (706) containing information that authorizes creation of additional tokens (600). These additional tokens can then circulate throughout the Fair Use P2P network as described previously for FIG. 6, until the super-node again captures them through use of its receiver and storage services.

Premium Super-Nodes

When a fair use P2P network super-node is affiliated with an authorized video content provider, the capabilities of the Fair Use P2P network and system become even more compelling. This is because, particularly when paired with a payment or micropayment system, the super-node can provide additional legally available video content to the Fair Use P2P network.

Here, for example, an authorized content provider (which need not necessarily be the same content provider that provides the widely distributed broadcast video channels A (220)), contracts with various authorized content sources to provide additional video program material to the Fair Use P2P network in exchange for micropayments.

Note that to implement this scenario, the software functionality of the various DVR units (200), (208), (210) in the Fair Use P2P network is must additionally have code or functionality instructing the DVR units to contact various super-nodes, inquire if they offer premium content, and if so, show the availability of this offered premium content to the various DVR viewers on a menu system. A local DVR user, then viewing this menu of premium content, may if interested then request access to the premium content in exchange for tokens or micro-payments.

Using this approach, the Fair Use P2P network thus serves as a simple, easily implemented and almost seamless system that begins with extending the functionality of very simple DVR units, and ends with the implementation of an entirely new type of content delivery and advertising delivery platform.

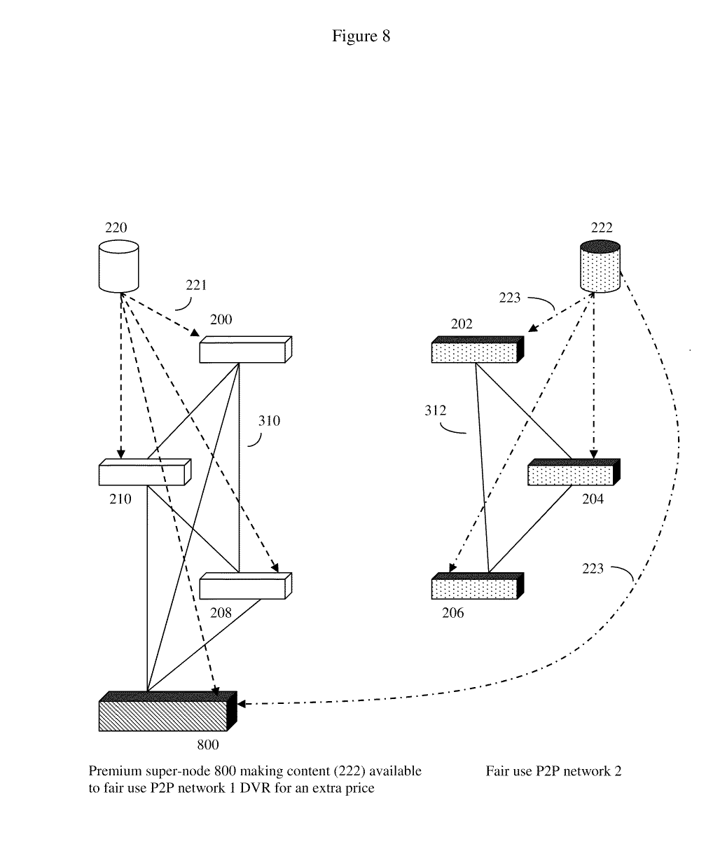

An example of this premium-content super-node approach is shown in FIG. 8. Here, the super-node (800) is run by an authorized content provider, which could be broadcast video content provider A (220), broadcast video content provider B (222), or a third content provider.

In this example, broadcast content provider B (222) has decided to attempt to extend its market by making its content available in the same service area as broadcast content provider A (220). Here however, content provider B is not going to do this for free, but rather will do so by either charging an additional service fee to view this content (i.e. this is premium content for the DVR normally served by broadcast video content provider A (220)), or by requiring that the DVR in service area “A” view extra commercials.

Here, a local DVR, such as (210) may use super-node (800) to access video programs from broadcast source B (222) that would not normally be available from broadcast source A (220). Here these extra programs can simply be extra programs that DVR (210) can ask to remotely record and playback. Alternatively, these extra programs can be prerecorded by super-node (800), and be available for DVR (200), (210), and (208) to download and view even if these DVR had not previously requested these programs. Here, because this is a premium fee service, the availability of these premium programs and prices for each can be negotiated with the content owners and may vary depending upon the particular content and market.

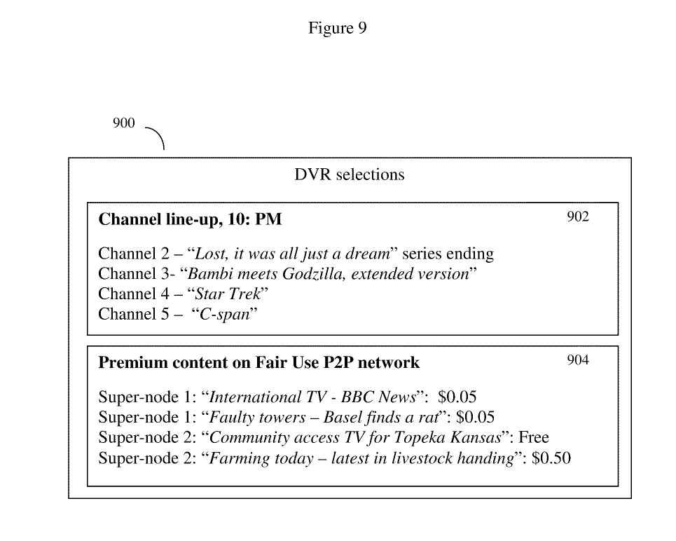

FIG. 9 shows an example of a hypothetical user interface display screen (900) of a DVR that is connected to a Fair Use P2P network with a premium super-node attached. In this example, the DVR shows the content associated with its main broadcast provider A (220) in the upper part of the display (902), and the premium content that is available from various premium super-nodes on the P2P network in the lower part of the display (904). The user may use a DVR remote control to select options from this user interface, according to standard DVR user interface rules.

Multiple Requestor Situations

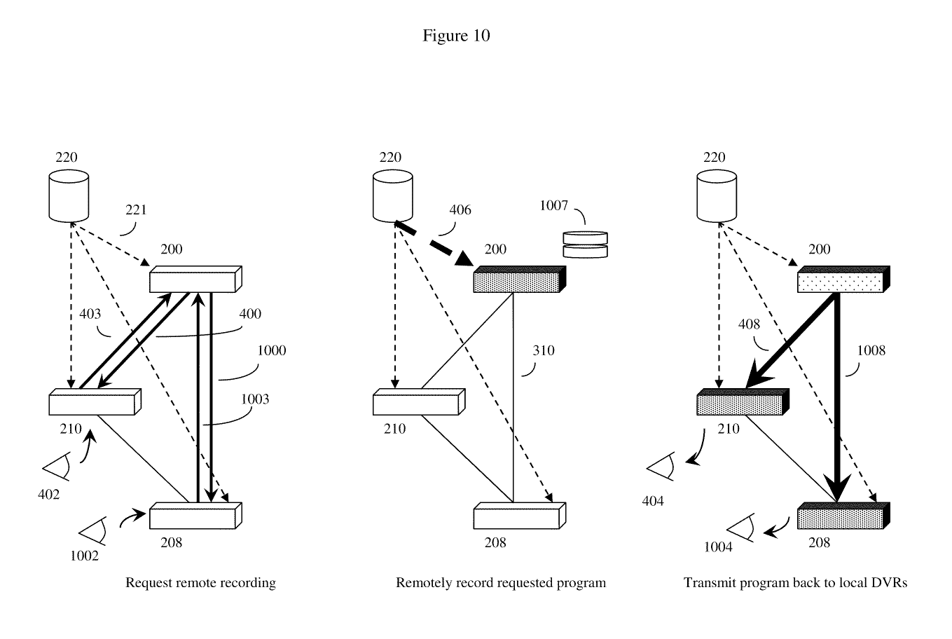

Often multiple requestor DVR units (210), (208) may wish to record the same program. Here, in order to improve the efficiency of the Fair Use P2P network, it will be useful to also allow the network protocols to enable one or more remote DVR units (200) to use the recorded program to satisfy more than one requestor DVR units (210), (208). This example is shown in FIG. 10.

In FIG. 10, the situation is similar to FIG. 4, except that now remote DVR device (200) has received a request both from local DVR device (210) and also from DVR device (208). That is, here user (1002) has also requested DVR (208) to record the same program as user (402), and a similar type of advertisement of excess storage space and/or storage space previously reserved for the same program (1000) and recording request message or request to also view the same previously reserved program (1003) has been sent between DVR (208) and remote DVR device (200). In this situation, however, remote DVR device (200) may store a counter in its memory (1007) keeping track of the fact that multiple requestor DVR units (210) and (208) may now wish to download the requested program.

After this situation has been established, remote DVR device (200) again records program (406). On playback, however, remote DVR device (200) can now send the program (408) back to DVR device (210) for viewing by user (404) (which may be the same user as (402), or alternatively a different authorized user), and also sends the program (1008) back to DVR device (208), where it now may be viewed by user (1008) (which may be the same user as (1002), or alternatively a different authorized user.

Here, remote device (200) would keep a copy of program (406) stored in memory until the number of previously arranged viewing requests had been satisfied and/or until some established time-out period, such as 30 days, had been exceeded.

This same type of principle may also be used when multiple remote DVR units are cooperating to either redundantly remotely record a program, or alternatively cooperate to remotely record a program in chunks.

Depending upon how far the operator wishes to push the bounds of the “fair use” copyright exception, remote DVR (200) may additionally keep a copy of program (406) in memory even after the program has been downloaded to units (210) and (208), and make this program available to other DVR units (not shown) that had not arranged in advance to record the program. In this case, the remote recording DVR unit may also follow additional P2P network protocols in which it responds to queries about remotely recorded program availability with an affirmative response message, even if the queries come from DVR units that had not originally arranged in advance to record the program.

Thus in this alternate embodiment, a Fair Use P2P DVR device may optionally also advertise the parameters (program identification, fair use criteria) of previously remotely recorded programs to other “new” Fair Use P2P DVR devices in the Fair Use P2P overlay network. Additionally, a “new” requestor Fair Use P2P DVR device might, rather than request that this previously recorded program be recorded in advance, alternatively simply request playback of these previously recorded programs. In this situation, the efficiency of the Fair Use P2P network would be much higher, because users would also be able to request playback of programs that they had forgotten to record and/or which they became interested in viewing after the broadcast date. Remote DVRs that had previously recorded these programs, within certain parameters (i.e. number of extra playback copies allowed and/or maximum post-playback lifetime that a stored copy can persist in remote DVR memory after the previous requestor DVR's had received their copies), would be able to respond to these requests and download the requested program to additional “new” DVR units as well. By suitable adjustment of the playback copy and stored post-playback time values, the fair use compliance of the Fair Use P2P network can be adjusted as appropriate.

As an example, although the length of time that a remote DVR may store a previously requested program in memory for a specific “old” requestor DVR can be fairly long (here limited more by the tolerance of the owner of the remote DVR for cluttering up his or her memory with extra program data), the length of time that a remote DVR may store a recorded program in memory for use by one or more “new” requestor DVRs that had not previously requested remote recording and storage may be much more limited. Often this maximum program storage lifetime after playback to all of the “old” requestor DVR that had previously requested remote recording and storage (maximum post-playback lifetime) may be zero, or perhaps only a few days. This is because longer maximum post-playback lifetime values tend to cut into the rights of the original broadcaster to re-broadcast the program.

Thus for strict fair use, number of extra playback copies=0, and maximum post-playback lifetime for program persistence after authorized playback to “old” requestor DVR=0. Thus after playback to the previously authorized “old” requestor DVR units, the program will then be erased from the memory of the remote (recording) DVR.

For more permissive fair use, these numbers can be greater than zero. In an alternative embodiment, the number of extra playback copies and/or the maximum post-playback lifetime can differ on a per-video program basis. Thus, for example, a broadcast station or other super node might publish a list of acceptable extra playback copies and/or maximum lifetime for persistence after authorized playback that varies from program to program.

Thus, for example, in a Fair Use P2P network where the broadcast station might be in the habit of rebroadcasting shows after a few days or a week, but with different commercials, the maximum post-playback lifetime might be set to a low value, such as a value between zero days and a few days (inclusive). This way, the broadcast station will not lose revenues on the later broadcast.

Although the forgoing provides examples of various ways in which the invention may be implemented, it should be appreciated that there will also be various variations and alternate embodiments of the concept that will also be apparent to those skilled in the art.

1. A method of collaborative video recording that allows a plurality of networked digital video recorder (DVR) devices to distribute the tasks of receiving and storing digital video content data among different DVR devices, comprising:
defining a Fair Use P2P overlay network that is a subset of said plurality of networked DVR devices, said subset comprising those DVR devices that have equal access ability and equal access privileges to receive said digital video content data, thereby defining a plurality of Fair Use P2P DVR devices;
said Fair Use P2P overlay network having network protocols;
directing said Fair Use P2P DVR devices to advertise their recording capability parameters to other Fair Use P2P DVR devices using said Fair Use P2P overlay network;
causing at least a first requestor Fair Use P2P DVR device to send messages on said Fair Use P2P overlay network requesting recording of said digital video content data at a first future time (media recording request);
causing at least a second receiver DVR device in said Fair Use P2P overlay network that has the capability to receive and store said digital video content data to acknowledge said media recording request, and then to receive and store said digital video content data on said second receiver DVR device;
causing, at a second time after said first future time, at least said first requestor Fair Use P2P DVR device to send messages to said second receiver DVR device requesting playback and transmission of said digital video content data back to said first requestor Fair Use P2P DVR device using said Fair Use P2P overlay network;
and using said first requestor Fair Use P2P DVR device to view said digital video content data.

2. The method of claim 1, in which said digital video content data constitutes a plurality of different digital video programs transmitted by at least one communications media capable of delivering the same digital video programs to a plurality of viewers, and said Fair Use P2P overlay network and said plurality of Fair Use P2P DVR devices are further defined by the steps of:
determining which DVR devices are capable of receiving data from the same communications media of said at least one communications media;
determining which DVR devices have the same receiving privileges for an individual digital video program selected from said plurality of different digital video programs;
and defining said Fair Use P2P overlay network and plurality of Fair Use P2P DVR devices to be those DVR devices that are capable of receiving data from said same communications media and said same receiving privileges.

3. The method of claim 1, in which said second receiver DVR device requires transmission of a use credit token from said first requestor Fair Use P2P DVR device to said second receiver DVR device prior to receiving and storing said digital video content data, prior to retransmitting said digital video content data back to said first requestor Fair Use DVR device, or immediately after retransmitting said digital video content data back to said first requestor Fair Use DVR device.

4. The method of claim 3, in which said use credit token can have a variable value that varies according to a function of the estimated amount of bytes of storage required for said digital video content data, amount of free storage space on said second receiver DVR device, and anticipated flexibility of said second receiver DVR device to receive said digital video content data at said first future time.

5. The method of claim 3, in which said second receiver DVR device can in turn reuse said use credit token to request other DVR devices on said Fair Use P2P overlay network to record and store programs for said second receiver DVR device.

6. The method of claim 3, in which said first requestor Fair Use P2P DVR device may purchase additional use credit tokens from a super-node device connected said Fair Use P2P overlay network.

7. The method of claim 6, in which said super-node device provides tokens in exchange for micropayments or in exchange for viewing commercials.

8. The method of claim 7, in which said super-node device provides additional premium video content to said fair use P2P network in exchange for micropayments or in exchange for viewing commercials.

9. The method of claim 1, in which multiple DVR devices in said Fair Use P2P overlay network agree to implement to said media recording request, and said first requestor Fair Use P2P DVR device accepts said multiple agreements, producing multiple recording DVR devices.

10. The method of claim 9, in which said subsets of said digital video content data are distributed among said multiple recording DVR devices, so that each of said multiple recording DVR device stores only a subset of said digital video content data;
and said multiple recording DVR devices transmit said subsets of said digital video content data back to said first requestor Fair Use P2P DVR device in a synchronized manner;
and said first requestor Fair Use PEP DVR device assembles said subsets of said digital video content data back to a full set of digital video content data.

11. The method of claim 10, wherein said synchronized manner is optimized for transmission on said Fair Use P2P overlay network.

12. The method of claim 9, in which complete copies of said digital video content data are stored on said multiple recording DVR devices, producing redundant backups of said digital video content data.

13. The method of claim 12, in which said complete copies of said digital video content data are stored on said multiple recording DVR devices in an encrypted form, thus allowing only said first requestor Fair Use P2P DVR device to decrypt and view said digital video content data.

14. The method of claim 1, in which at least some of said protocols and at least some user interfaces for said Fair Use P2P overlay network are stored in the memory of a DVR device equipped with a network interface, and in which at least some of said protocols and user interfaces for said Fair Use P2P network are executed by at least one processor in said DVR device.

15. A method of collaborative video recording that allows a plurality of networked digital video recorder (DVR) devices to distribute the tasks of receiving and storing digital video content data among different DVR devices, comprising:
defining a Fair Use P2P overlay network that is a subset of said plurality of networked DVR devices, said subset comprising those DVR devices that have equal access ability and equal access privileges to receive said digital video content data, thereby defining a plurality of Fair Use P2P DVR devices;
directing said Fair Use P2P DVR devices to advertise their recording capability parameters to other Fair Use P2P DVR devices using said Fair Use P2P overlay network;
causing at least a first requestor Fair Use P2P DVR device to send messages on said Fair Use P2P overlay network requesting recording of said digital video content data at a first future time (media recording request);
causing at least a second receiver DVR device in said Fair Use P2P overlay network that has the capability to receive and store said digital video content data to acknowledge said media recording request, and then to receive and store said digital video content data on said second receiver DVR device;
causing, at a second time after said first future time, at least said first requestor Fair Use P2P DVR device to send messages to said second receiver DVR device requesting playback and transmission of said digital video content data back to said first requestor Fair Use P2P DVR device using said Fair Use P2P overlay network;
using said first requestor Fair Use P2P DVR device to view said digital video content data;
and in which at least one Fair Use super-node is also connected to said Fair Use P2P overlay network that is capable of supplying additional services to said Fair Use P2P overlay network.

16. The method of claim 15, in which said Fair Use super-node maintains a list of broadcast digital media sources and the broadcast characteristics of said broadcast digital media sources, and a list of different Fair Use DVR devices and the DVR characteristics of said different Fair Use DVR devices;
wherein said Fair Use super-node determines the DVR characteristics of a Fair Use DVR that connects to said Fair Use super-node by said Fair Use P2P network, and assigns said Fair Use DVR device a media access code that corresponds to said broadcast characteristics of said broadcast digital media source that supplies digital video content data to said Fair Use DVR device;
and in which said Fair Use DVR devices use said media access codes as a criteria to determine if another DVR device has equal access ability and equal access privileges to receive said digital video content data.

17. The method of claim 16, in which said broadcast characteristics of said broadcast digital media source are selected from the group consisting of geographical distribution of content, type of content, and content service levels, and in which said DVR characteristics of said Fair Use DVR devices are selected from the group consisting of DVR location, DVR broadcast service provider, and DVR service level.

18. A method of collaborative video recording that allows a plurality of networked digital video recorder (DVR) devices to distribute the tasks of receiving and storing digital video content data among different DVR devices, comprising:
defining a Fair Use P2P overlay network that is a subset of said plurality of networked DVR devices, said subset comprising those DVR devices that have equal access ability and equal access privileges to receive said digital video content data, thereby defining a plurality of Fair Use P2P DVR devices;
directing said Fair Use P2P DVR devices to advertise their recording capability parameters to other Fair Use P2P DVR devices using said Fair Use P2P overlay network;
causing at least a first requestor Fair Use P2P DVR device to send messages on said Fair Use P2P overlay network requesting recording of said digital video content data at a first future time (media recording request);
causing at least a second receiver DVR device in said Fair Use P2P overlay network that has the capability to receive and store said digital video content data to acknowledge said media recording request, and then to receive and store said digital video content data on said second receiver DVR device;
causing, at a second time after said first future time, at least said first requestor Fair Use P2P DVR device to send messages to said second receiver DVR device requesting playback and transmission of said digital video content data back to said first requestor Fair Use P2P DVR device using said Fair Use P2P overlay network;
using said first requestor Fair Use P2P DVR device to view said digital video content data;
in which at least one super-node is also connected to said Fair Use P2P overlay network that is capable of supplying additional services to said Fair Use P2P overlay network;
and in which tokens are exchanged between said first requestor Fair Use P2P DVR device and said second receiver DVR device or said super-node in response to said media recording requests and said playback and transmission of said digital video content data.

19. The method of claim 18, in which said super-node provides additional capability to receive said digital video content data and store said digital video content data in exchange for tokens, viewing commercials, or payment.

20. The method of claim 18, in which said super-node provides additional digital video content data outside of the equal access ability and equal access privileges of the Fair Use P2P network in exchange for tokens, viewing commercials, or payment.

21. A method of collaborative video recording that allows a plurality of networked digital video recorder (DVR) devices to distribute the tasks of receiving and storing digital video content data among different DVR devices, comprising:
defining a Fair Use P2P overlay network that is a subset of said plurality of networked DVR devices, said subset comprising those DVR devices that have equal access ability and equal access privileges to receive said digital video content data, thereby defining a plurality of Fair Use P2P DVR devices;
said Fair Use P2P overlay network having network protocols;
directing said Fair Use P2P DVR devices to advertise their recording capability parameters, or parameters of a previously recorded program, to other Fair Use P2P DVR devices using said Fair Use P2P overlay network;
causing at least a first requestor Fair Use P2P DVR device to send messages on said Fair Use P2P overlay network requesting recording of said digital video content data at a first future time (media recording request), or requesting playback of said previously recorded program;
causing at least a second receiver DVR device in said Fair Use P2P overlay network that has the capability to receive and store said digital video content data to acknowledge said media recording request, and then to receive and store said digital video content data on said second receiver DVR device, or to playback said previously recorded program to said first requestor Fair Use P2P DVR device;
and if said first requestor Fair Use P2P DVR device has requested recording, causing, at a second time after said first future time, at least said first requestor Fair Use P2P DVR device to send messages to said second receiver DVR device requesting playback and transmission of said digital video content data back to said first requestor Fair Use P2P DVR device using said Fair Use P2P overlay network;
and using said first requestor Fair Use P2P DVR device to view said digital video content data.
